(19) United States
(12) Patent Application Publication
(10) Pub. No.: US 2009/0107773 A1
(43) Pub. Date: Apr. 30, 2009

(54) FRONT TRANSPORT FOR CHECK STAND

(75) Inventors: Michael S. Notheis, Hoschton, GA (US); Earl Seekins, Marietta, GA (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: ROYSTON, LLC, Jasper, GA (US)

(21) Appl. No.: 11/923,821

(22) Filed: Oct. 25, 2007

(51) Int. Cl. B65G 15/00; B65G 23/44; G06M 7/00

(52) U.S. Cl. 186/68; 198/813; 198/816

(57) ABSTRACT

This invention relates to a front transport for a check stand which has a combined front roller and motor and an idler roller at the rear end with a conveyor belt going around both rollers. The front transport has a mechanism for adjusting the tension and tracking of the conveyor belt which consists of two bolts on the front end of the front transport near each side for adjusting a shuttle on each in which a motor mount is secured. Each shuttle can be moved back and forth by turning the adjustment bolt. This front transport can have varying lengths as it has break points in the metal frame for reducing the size of the conveyor assembly.

### TECHNICAL FIELD

The present invention generally relates to a new front transport with a conveyer belt assembly for a check stand for a store.

### BACKGROUND OF THE INVENTION

The check stand for a store, where a customer pays for products, typically has a front transport on which the customer places products to be checked by the cashier. Many of these check stands have a conveyer belt which moves the products towards the cashier for scanning and checkout. This front transport has a front end where customers load the products and a rear end near where the cashier is located where the products are taken off of the conveyer belt and scanned by an adjacent scanner. This front transport has a base support in which various cabinets are located for access by the cashier. The conveyer belt is looped around two rollers; one at the front end and the second at the rear end where the cashier is located. The conveyer belt is moved by an electric motor driving a roller at the rear end of the front transport. This motor pulls the top loop of the conveyor belt where the products are resting from the front to the rear of the front transport.

A cash drawer is typically located near the rear of the front transport in the base of the front transport for use by the cashier. The size of the motor driving the rear roller has required that the cash drawer be placed closer to the floor than what is desirable for easy access by the cashier. The American Disabilities Act now requires easier access to the cash drawer by the cashier. This means that the cash drawer should be located farther from the floor. To date this has not been possible because of the size of the rear roller and the motor driving the roller for the front transport. It would be desirable if a front transport could be developed where the cash drawer could be raised farther from the floor.

In order for the front transport to operate satisfactorily, the conveyer belt needs to be on the correct track from right to left and also under the proper tension to run smoothly. The mechanism for putting tension on the conveyer belt and for establishing the proper tracking of the conveyer belt presently is located at the rear of the front transport. This is an inconvenient location in order to make the necessary adjustments because of the location of cabinets in this location.

Different types of stores require a front transport of different lengths. The different lengths are required because of the type of merchandise and the type of operation the store is conducting.

### SUMMARY OF THE INVENTION

The front transport of this invention has a drive motor and front roller that is placed at the front end of the transport where the products are loaded by the customer. The idler roller, which is smaller in diameter than the front roller, is placed at the rear end of the front transport near where the scanner or cashier is located. A second idler roller may be placed in the middle of the front transport at the bottom to take up belt slack by applying pressure to the returning belt. Putting the motor at the front end of the transport results in pushing the belt along the top surface of the base of the front transport towards the cashier. This arrangement allows the cash drawer to be placed near the rear of the front transport adjacent the scanner or cashier section. The smaller diameter of the idler roller allows the cash drawer to be placed farther from the floor when the front transport has been installed.

Shuttles are used in which the mounts for the combined motor and front roller are secured for adjusting the tension and tracking of the conveyor belt on the rollers. Shuttles support the electric motor and in turn are supported by support brackets on each side at the front end of the front transport. Tension and tracking of the belt on the rollers is adjusted by a right and left bolt placed on the front end of the transport which pulls the shuttle back and forth to adjust the tension and tracking of the belt.

Efficiency in manufacture and assembly of the front transport is achieved by the use of modular construction. The marketplace demands front transports of different lengths and with different features. These demands are met by conceptually breaking the front transport into three basic modules. A pedestal cabinet, which can be provided in a length of 38 inches, is used to support the conveyer assembly. The pedestal cabinet can be composed of two compartments that are 14 inches and 24 inches in length. These compartments can have shelves, drawers and a number of other features. A filler cabinet of variable lengths, such as 16, 22, 28, 34, 40 and 46 inches, is provided to support the conveyor assembly. The variable lengths of the filler cabinet allow for the production of front transports of different lengths. These transports of different lengths can be constructed very easily because of the modular construction applied to the filler cabinet. The conveyor assembly consists of the conveyor belt, motor, idler roller and frame for support. The rear end of the conveyor assembly has a fixed length, while the front end has a variable length.

By using this modular construction it is possible to easily manufacture a right or left handed unit as required by the marketplace. Each of the modules and sub-modules are preferably formed from sheet metal panels and common hardware parts which enables the length of the front transport to be easily varied.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views.

FIG. 1 is a perspective view of the front transport of this invention.

FIG. 2 is a perspective view of the conveyor assembly of this invention.

FIG. 3 is a perspective view of the front end of the front transport of this invention.

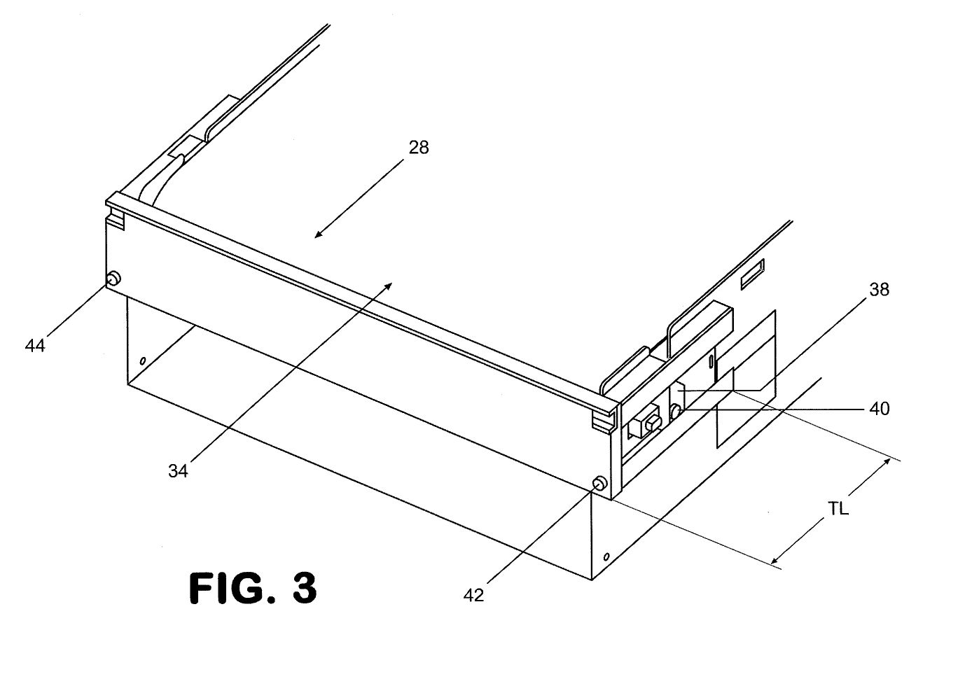

FIG. 4 is a perspective view of the front end of the front transport showing the components.

### DETAILED DESCRIPTION OF THE PREFERRED EMBODIMENT

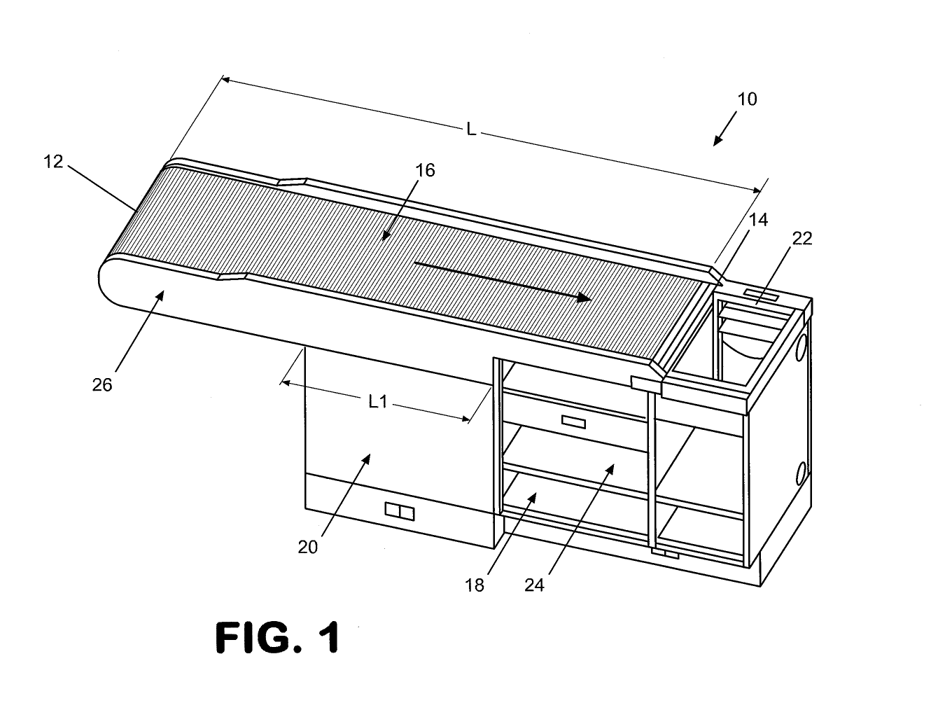

This invention relates to an improved front transport for a check stand in which customers in a store place products to be scanned, paid for, bagged and taken out of the store. This front transport of the check stand is illustrated in FIG. 1. The check stand also has a scanner section and a rear end for the bagging of products for taking out of the store, which are not illustrated.

The following Parts Number List is provided for convenience in understanding the drawings.

Parts Number List

| | |
|---|---|
| 10 | Front Transport |
| 12 | Front End |
| 14 | Rear End |
| 16 | Conveyor |
| 18 | Pedestal Cabinet |
| 20 | Filler Cabinet |
| L | Length |
| L1 | Length of Filler Cabinet |
| 22 | Scanner Location |
| 24 | Cash Drawer |
| 26 | Conveyor Assembly |
| 28 | Conveyor Belt |
| FL | Fixed Length |
| VL | Variable Length |
| 30 | Rear End Idler Roller |
| 32 | Center Idler Roller |
| 34 | Front End |
| 35 | Front Roller and Motor |
| TL | Tension Adjustment Length |
| 38 | Right Belt Adjustment Shuttle |
| 40 | Right Support Bracket |
| 42 | Right Shuttle Adjustment Bolt |
| 44 | Left Shuttle Adjustment Bolt |
| 46 | Break Points |
| 48 | Frame |
| 50 | Joining Section |
| 52 | Fixed Section of Conveyor Assembly |
| 54 | Variable Section of Conveyor |
| | Assembly |
| 56 | Right Slot |
| 58 | Left Slot |
| 60 | Left Belt Adjustment Shuttle |
| 62 | Right Threaded Aperture |
| 64 | Left Threaded Aperture |
| 66 | Right End Motor Mount |

FIG. 1 is a perspective view of the front transport of this invention.

The front transport 10 is similar in appearance to current front transports that are used with check stands. The front transport 10 has a front end 12 where customers load products to be purchased. It also has a rear end 14, which is located next to where the cashier stands. Products are conveyed from the front end 12 to the rear end 14 by a conveyer 16. A pedestal cabinet 18 and filler cabinet 20 support the front transport 10. The conveyor has a length L which may be easily varied in manufacture. The pedestal cabinet 18 typically has a set length and the filler cabinet 20 may have a length that is varied depending upon need of the purchaser.

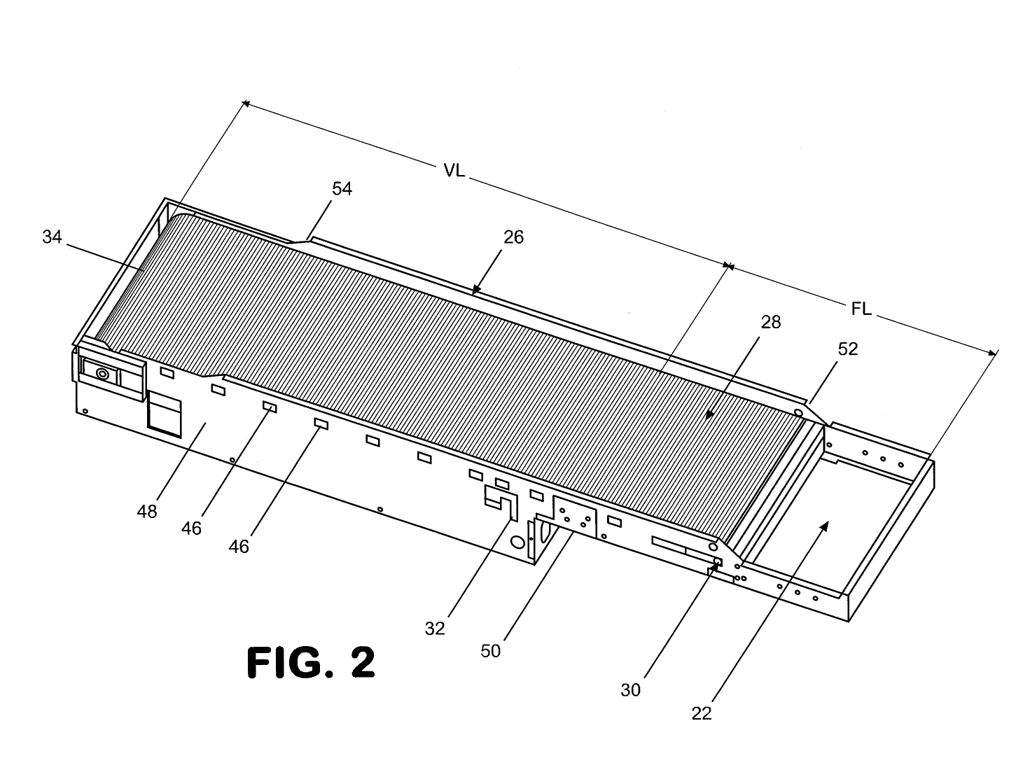

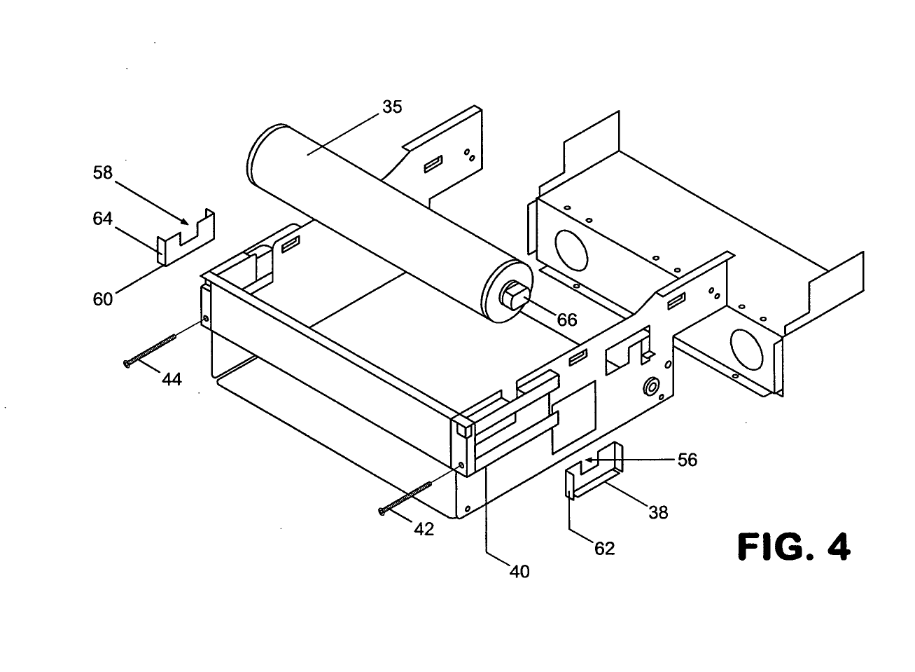

The conveyor assembly 26 is best illustrated in FIG. 2. The conveyor assembly 26 has a conveyor belt 28 which is looped around front roller 35 with a motor (FIG. 4) and a rear end idler roller 30 and a center idler roller 32 to take slack out of the conveyor belt 28. Since the motor is located at the front end 34 of the front transport more space is provided at the rear end 14 so that a cash drawer 24 can be located farther from the floor for the convenience of the cashier and to satisfy the requirements of the American's Disability Act. It is located close to the scanner location 22 for the convenience of the cashier who stands adjacent that location. As shown in FIG. 4, a right and left belt adjustment shuttle 38 and 60 is provided for the support of the front roller and motor 35. Right shuttle 38 slides back and forth in right support bracket 40. Motor right end mount 66 is secured in right slot 56 of shuttle 38. The motor left end mount (not shown) is secured in left slot 58 of left belt adjustment shuttle 60. Right and left adjustment bolts 42, 44 are secured in right and left threaded apertures 62 and 64. Right support bracket 40 is secured to the frame 48. The right and left shuttles 38, 60 along with front roller 35 move freely back and forth with the shuttles sliding freely in the support brackets. There is a left carrier bracket adjustment bolt 44 attached to left shuttle 60. Adjusting both of the bolts 42 and 44 will increase tension on the belt while adjusting one or the other of the bolts 42 and 44 will effect the tracking of the belt. This adjustment can be made without moving the front transport or removing any panel for accomplishing the adjustment.

Because stores have different requirements for the front transport, they frequently want front transports of different lengths. This can be accomplished by designing and building the conveyor assembly 26 having a fixed length FL and a variable length VL. The fixed length is usually 38 inches in length which is the same length as the pedestal cabinet 18 upon which it rests. The fixed length FL of the conveyor assembly 26 is illustrated in FIG. 2. The filler cabinet 20 is typically offered in the following lengths: 16 inches, 22 inches, 28 inches, 34 inches, 40 inches and 46 inches. The filler cabinet 20 also supports the conveyor assembly 26. The conveyor assembly 26 has a variable length VL which can be shortened at a series of break points 46 where the frame 48 can be shortened. It is then only necessary to provide the appropriate length for the conveyor belt 28. The fixed section 52 of the conveyor assembly 50 is attached to the variable section 54 of the conveyor assembly by joining section 50 on each side of the frame 48. Since the frame 48 of the conveyor assembly 26 is usually made of steel the joining section 50 can be simply welded to put the fixed section 52 and variable section 54 together.

Trim panels can be used to cover the basic structure of the front transport 10. The trim panels can be produced in the appropriate size and length to accommodate the basic structure of the front transport 10. The modular structure of this front transport 10 permits easy assembly into either a left hand or right hand front transport.

By placing the rear end idler roller 30 at the rear end 14 of the front transport 10, more vertical space is provided for the location of the cash drawer 24. Placing the drive motor at the front end 12 of the front transport facilitated the development of an adjustment system is based upon only two adjustment points. In the past, three to four adjustment points were required at the motor access and idler rollers which was more complicated and required the removement of panels to accomplish the adjustment. The placement of the roller 35 combined with the motor at the front end results in the belt being pushed along the top surface of the conveyor assembly 26 rather than being pulled as in the present front transports. The second idler belt roller as shown by the arrow in FIG. 1 been added to take out belt slack and control the belt path by lifting the belt to create space for the cash drawer.

Therefore, having thus described the invention, at least the following is claimed:

1. A front transport for inclusion in a check stand, said front transport having a front end and rear end joined by two sides, said front transport having a pedestal cabinet at the rear end and a filler cabinet at the front end, each cabinet having a top and bottom, with the bottom of each designed to rest on a floor, and a conveyor assembly which has a conveyor belt extending around an idler roller at the rear end and a front roller at the front end with a motor to power the front roller, said conveyor assembly having a frame for support, said conveyor assembly resting on the top of said cabinets, said front transport being designed for a shopper in a store to place items to be purchased on the conveyor belt at the front end of the front transport for transport to the rear end, said conveyor assembly having means to adjust the tension on the conveyor belt and the tracking of the conveyor belt over said front and rear rollers to provide a firm surface to transport items on the conveyor belt by moving the front roller either away from or towards the rear end of the front transport at a single adjustment point near each side of said front transport on the front end, said front transport having means to secure the pedestal and filler cabinets and conveyor assembly together as the front transport.

2. The front transport of claim 1 in which the frame for the transport component is composed of a back section of a fixed length and a front section which may be manufactured in multiple lengths as desired, with the back and front section selected being easily fastened together to complete the manufacture of the frame by utilizing a joining section to fasten the front and back sections together.

3. The front transport of claim 2 in which the frame is constructed of metal with the back, front and joining sections being attached together by metal fasteners.

4. The front transport of claim 1 in which the means to adjust tension and tracking of the belt consists of two adjustment bolts secured to the front of the front transport, said adjustment bolts can be turned to move the front roller away from or towards the rear roller as desired.

5. The front transport of claim 1 in which there is an idler roller to provide tension on the belt in the midsection of the frame.

6. A front transport for inclusion in a check stand, said front transport having a front end and rear end joined by two sides, said front transport having a bottom support for resting on a floor, and a conveyor assembly which has a conveyor belt extending around an idler roller at the rear end and a front roller at the front end with a motor to power the front roller, said conveyor assembly having a frame, said conveyor assembly resting on said bottom support, said front transport being designed for a shopper in a store to place items to be purchased on the conveyor belt at the front end of the front transport for transport to the rear end, said conveyor assembly having means to adjust the tension on the conveyor belt and the tracking of the conveyor belt over said front and rear rollers to provide a firm surface to transport items on the conveyor belt by moving the front roller either away from or towards the rear end of the front transport at a single adjustment point near each side of said front transport on the front end, said front transport having means to secure the support and conveyor assembly together as the front transport.

7. The front transport of claim 6 in which the means to adjust tension and tracking of the belt consists of two adjustment bolts secured to the front of the front transport, said adjustment bolts can be turned to move the front roller away from or towards the rear roller as desired.

8. A front transport for inclusion in a check stand, said front transport having a front end and rear end joined by two sides, said front transport having a bottom support for resting on a floor, and a conveyor assembly which has a conveyor belt extending around an idler roller at the rear end and a front roller at the front end with a motor to power the front roller, said conveyor assembly having a frame, said conveyor assembly resting on said bottom support, said front transport being designed for a shopper in a store to place items to be purchased on the conveyor belt at the front end of the front transport for transport to the rear end, said front roller having a right and left end and being supported by a mount on each end which is secured to shuttle which is free to move towards and away from the rear roller in a bracket firmly attached to each side of the front transport, with an adjustment bolt secured to the front of the front transport near each side, with each bolt secured to a shuttle, so that turning the bolt moves the front roller either away from or towards the rear roller to adjust the tension on the conveyor belt and the tracking of the conveyor belt over said front and rear rollers to provide a firm surface to transport items on the conveyor belt, said front transport having means to secure the support and conveyor assembly together as the front transport.

9. The front transport of claim 8 in which the front roller is combined with an electric motor.

10. A check stand which has a scanner section and rear section where products that have been scanned can be placed for pick up by customers, said check stand having a front transport for delivering products being purchased to the scanner, said front transport having a front end and rear end joined by two sides, said front transport having a pedestal cabinet at the rear end and a filler cabinet at the front end, each cabinet having a top and bottom, with the bottom of each designed to rest on a floor, and a conveyor assembly which has a conveyor belt extending around an idler roller at the rear end and a front roller at the front end with a motor to power the front roller, said conveyor assembly having a frame, said conveyor assembly resting on the top of said cabinets, said front transport being designed for a shopper in a store to place items to be purchased on the conveyor belt at the front end of the front transport for transport to the rear end, said conveyor assembly having means to adjust the tension on the conveyor belt and the tracking of the conveyor belt over said front and rear rollers to provide a firm surface to transport items on the conveyor belt by moving the front roller either away from or towards the rear end of the front transport at a single adjustment point near each side of said front transport on the front end, said front transport having means to secure the pedestal and filler cabinets and conveyor assembly together as the front transport.

11. The check stand of claim 10 in which the front roller is combined with an electric motor.

12. The check stand of claim 11 in which a cash drawer is placed in the pedestal cabinet in proximity to the conveyor assembly.

13. The check stand of claim 12 in which the means to adjust tension and tracking of the belt consists of two adjustment bolts secured to the front of the front transport, said adjustment bolts can be turned to move the front roller away from or towards the rear roller as desired.
